(19) United States
(12) Patent Application Publication
(10) Pub. No.: US 2002/0134194 A1
(43) Pub. Date: Sep. 26, 2002

(54) Axle housing cover with variable thickness

(76) Inventor: Raymond A. Milio, Troy, MI (US)

Correspondence Address: William S. Gottschalk, Carlson, Gaskey & Olds, P.C., Ste. 350, 400 W. Maple Rd., Birmingham, MI, 48009, US

(21) Appl. No.: 09/814,016

(22) Filed: Mar. 21, 2001

(51) Int. Cl. F16H 57/02

(52) U.S. Cl. 74/607

(57) ABSTRACT

An axle housing cover is provided including a generally dome-shaped portion having a first thickness with the dome-shaped portion terminating in a perimeter edge. The perimeter edge has a second thickness greater than the first thickness with the perimeter edge providing a weld surface. Preferably, the second thickness is approximately twice that of the first thickness. Since the dome-shaped portion has a reduced thickness, reinforcing ribs may be formed in the dome-shaped portion to provide increased structural integrity. The cover may include a flange extending radially from the cover, which provides the weld surface that is then welded to the axle housing. The axle housing cover may be formed by a stamping or a hydroforming process.

### BACKGROUND OF THE INVENTION

This invention relates to an axle housing cover, and more particularly, the invention relates to an axle housing cover that is welded to an axle housing to enclose the differential.

Axle housings, particularly those used for commercial vehicles, have a rather large opening for receiving the differential, which connects opposing axle shafts. The opening is closed by an axle housing cover which is welded to the axle housing. Because the opening in the axle housing is rather large, the axle housing provides structural integrity to the axle assembly. Depending upon the size of the opening in the axle housing and other factors an axle housing cover of a particular thickness may be desirable. Due to different axle housing configurations and different size openings, it is not uncommon to manufacture three or more axle housing covers, each having a different thickness. For example, a cover may have a thickness of approximately 9.5 to 10 millimeters for axle housings with a rather large opening requiring increased structural integrity.

Axle housing covers include dome-shaped or concave portions that typically including a flange. The flange is welded to the axle housing about the opening. The thickness of the cover in the area of the weld provides increased structural integrity to the axle housing about the opening. Furthermore, the thickness provides a weld surface to which a weld bead may be applied to connect the cover to the axle housing. The thickness of the cover that is typically desirable in the area of the perimeter edge is usually not necessary for the rest of the cover. Moreover, the axle housing cover typically has a uniform thickness. As a result, the cover is unnecessarily thick in the dome-shaped portion of the cover, which increases the weight and cost of the cover. Therefore, what is needed is a variable thickness cover which provides adequate thickness in the area of the weld while providing a reduced thickness in the dome-shaped portion of the cover.

### SUMMARY OF THE INVENTION AND ADVANTAGES

The present invention provides an axle housing cover includes a generally dome-shaped portion having a first thickness with the dome-shaped portion terminating in a perimeter edge. The perimeter edge has a second thickness greater than the first thickness with the perimeter edge providing a weld surface. Preferably, the second thickness is approximately twice that of the first thickness. Since the dome-shaped portion has a reduced thickness, reinforcing ribs may be formed in the dome-shaped portion to provide increased structural integrity. The cover may include a flange extending radially from the cover, which provide the weld surface that is then welded to the axle housing. The axle housing cover may be formed by a stamping or a hydroforming process.

Accordingly, the present provides a variable thickness cover that provides adequate thickness in the area of the perimeter edge while providing a reduced thickness in the dome-s shaped portion of the cover.

### BRIEF DESCRIPTION OF THE DRAWINGS

Other advantages of the present invention can be understood by reference to the following detailed description when considered in connection with the accompanying drawings wherein:

FIG. 1 is a cross-sectional view of the present invention cover taken along lines 1-1 of FIG. 2;

FIG. 2 is a top elevational view of the present invention cover;

FIG. 3 is an enlarged view of a perimeter edge of the cover shown in circle 3 of FIG. 1;

FIG. 4 is an enlarged view of an alternative embodiment of the perimeter edge;

FIG. 5 is an enlarged view of another alternative embodiment of the perimeter edge;

FIG. 6 is a cross-sectional view of the present invention cover with a recessed boss; and

FIG. 7 is a cross-sectional view of a spherical shell formed during a hydroforming process to form two present invention covers.

### DETAILED DESCRIPTION OF THE PREFERRED EMBODIMENT

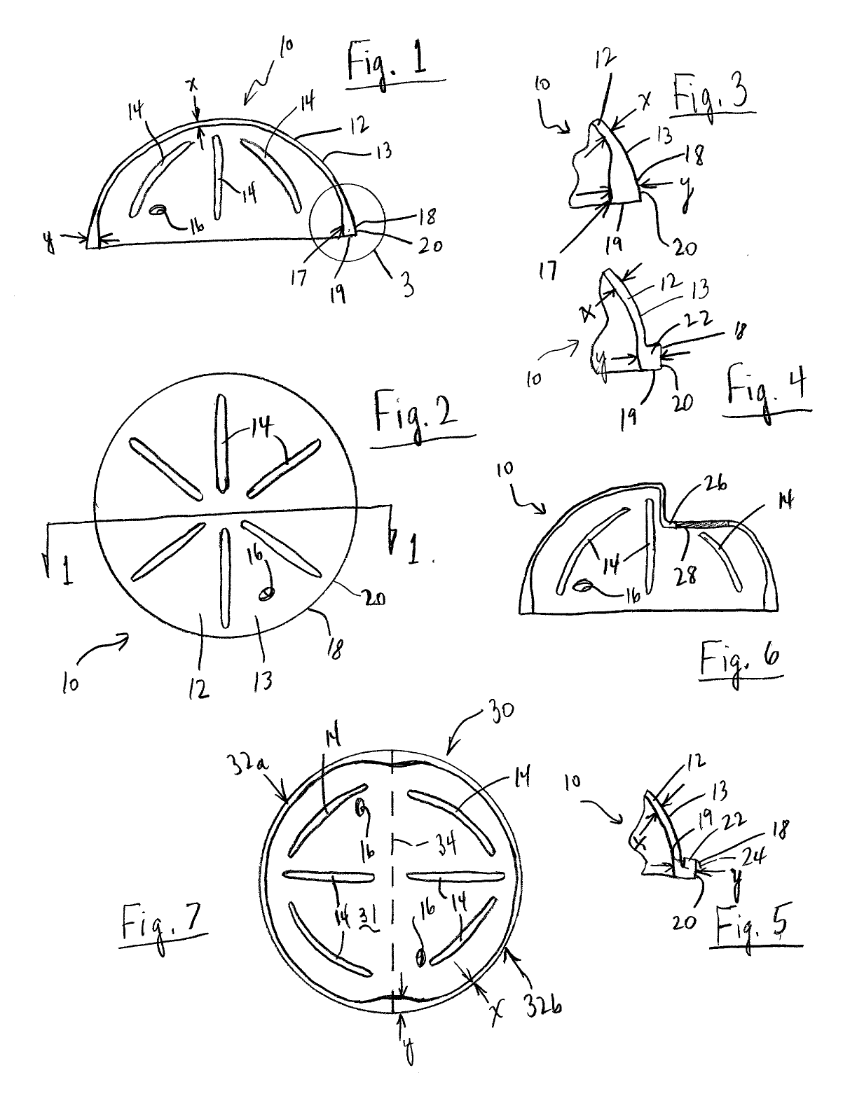

An axle housing cover 10 is shown in FIGS. 1 and 2. The cover 10 includes a dome- or concave-shaped portion 12 having a concave exterior surface 13. The dome-shaped portion 12 has a first thickness X. The dome-shaped portion 12 commonly includes an oil drain/fill hole 16. The cover 10 includes a terminal portion 17 having a circular terminal end 19 that engages the axle housing. The terminal portion 17 has a perimeter edge 18 with a second thickness Y. Preferably, the second thickness Y is approximately twice that of the first thickness X. For example, the first thickness may be in a range of 4.0 to 4.5 millimeters and the second thickness may be in a range of approximately 9.5 to 10.0 millimeters. The perimeter edge 18 provides a weld surface 20 to which a weld bead is applied to secure the cover 10 to the axle housing about the opening in the housing.

Because the thickness of the dome-shaped portion 12 is reduced when compared to prior art covers, it may be desirable to form reinforcing ribs 14 into the dome-shaped portion 12 to provide increased structural integrity. By providing a cover 10 with a variable thickness, structural integrity in the area of the perimeter edge 18 may be provided while reducing the thickness in the rest of the cover 10 to reduce the weight and cost of the cover. Maintaining a suitably large thickness in the area of the perimeter edge 18 ensures that an adequate weld bead may be used between the cover 10 and the axle housing and that the weld does not bum through the cover during the welding process.

One embodiment of the perimeter edge 18 is shown in FIG. 3. In the embodiment shown, the perimeter edge 18 does not extend beyond the concave exterior surface 13. That is, the perimeter edge is not defined by a flange. Conversely, in another embodiment shown in FIG. 4, a flange 22 extends radially outwardly from the dome-shaped portion 12 to provide the perimeter edge 18. The flange may be formed by folding the terminal end 19 of the dome-shaped portion back onto itself, shown in FIG. 5. After the flange 22 has been formed a rounded portion 24 may be machined from the flange 22 to provide a flat weld surface 20.

The cover 10 may include a recessed boss 26 having an opening 28, as shown in FIG. 6, formed into the cover 10 by stamping. A carrier assembly may be installed onto the boss 26 so that the carrier may be connected to the differential assembly within the axle housing.

The cover 10 of the present invention may be formed using any number of suitable processes. A blank may be provided having a uniform thickness. The dome-shaped portion may then be formed to obtain a first thickness. The perimeter edge may be formed having a second thickness which is greater than the first thickness. The second thickness may be the original thickness of the blank. The cover may be formed using a stamping process or a hydroforming process. For example, a hollow blank 30 may be used having a cavity 31, as shown in FIG. 7. Fluid is injected into the cavity 31 through one of the oil drain/fill holes 16.

The hollow blank 30 is deformed outward and into engagement with a mold having the desired exterior shape of the cover 10. The hollow blank 30 would be formed into the spherical shell shown in FIG. 7. The blank 30 may be cut along plane 34 to form a first and second covers 32a and 32b. The ribs 14 may be defined by the shape of the mold.

The invention has been described in an illustrative manner, and it is to be understood that the terminology that has been used is intended to be in the nature of words of description rather than of limitation. Obviously, many modifications and variations of the present invention are possible in light of the above teachings. It is, therefore, to be understood that within the scope of the appended claims the invention may be practiced otherwise than as specifically described.

What is claimed is:

1. An axle housing cover comprising:
a generally dome-shaped portion having a first thickness, said dome-shaped portion terminating in a perimeter edge having a second thickness greater than said first thickness with said perimeter edge providing a weld surface.

2. The cover according to claim 1, wherein said second thickness is approximately twice said first thickness.

3. The cover according to claim 1, wherein said dome-shaped portion includes a plurality of reinforcing ribs protruding therefrom.

4. The cover according to claim 3, wherein said ribs are arranged radially about said dome-shaped portion.

5. The cover according to claim 1, wherein said dome-shaped portion includes a concave exterior surface, and said perimeter edge is a flange extending radially outwardly from said concave exterior surface.

6. The cover according to claim 5, wherein said flange is defined by a portion of said dome-shaped portion folded back onto itself.

7. The cover according to claim 6, wherein said weld surface is a machined circumference of said flange.

8. The cover according to claim 1, wherein said dome-shaped portion includes a recessed boss with an opening for receiving a carrier.

9. The cover according to claim 1, wherein dome-shaped portion includes a concave exterior surface with said perimeter edge defined by a terminal portion of said concave exterior surface.

10. A method of forming an axle housing cover, comprising the steps of:
a) providing a blank;
b) forming a dome-shaped portion having a first thickness; and
c) forming a perimeter edge having a second thickness greater than the first thickness with the perimeter edge providing a weld surface.

11. The method according to claim 10, wherein step a) includes a hollow blank having a cavity with at least one hole through the blank into the cavity, and step b) includes hydroforming the blank to thin the blank to the first thickness.

12. The method according to claim 11, further including step d) cutting the blank in half to provide a pair of axle housing covers.

13. The method according to claim 10, wherein step b) includes forming a plurality of reinforcing ribs in the dome-shaped portion.

14. The method according to claim 10, wherein step c) includes folding a portion of the dome-shaped portion onto itself to form a flange extending radially outwardly from the dome-shaped portion.

15. The method according to claim 14, wherein step c) further includes machining a weld surface on the flange.

16. The method according to claim 10, further including step e) forming a recessed boss on the dome-shaped portion for receiving a carrier.

17. The method according to claim 10, wherein step b) includes stamping the blank.
